(19) United States
(12) Patent Application Publication
(10) Pub. No.: US 2024/0074525 A1
(43) Pub. Date: Mar. 7, 2024

(54) HUMBLE HEADBAND HAIR ACCESSORY

(71) Applicants: Kelly L. Romlein, Milford, PA (US); Kyle A. Werner, Milford, PA (US)

(72) Inventors: Kelly L. Romlein, Milford, PA (US); Kyle A. Werner, Milford, PA (US)

(21) Appl. No.: 18/177,069

(22) Filed: Mar. 1, 2023

Related U.S. Application Data
(60) Provisional application No. 63/474,644, filed on Sep. 1, 2022.

(51) Int. Cl. A41D 20/00; H04R 1/08; H04R 1/10

(52) U.S. Cl. CPC A41D 20/00; H04R 1/08; H04R 1/1008; H04R 1/1041; H04R 1/105; H04R 1/1075; H04R 2420/07

(57) ABSTRACT

A novel headband is described having a headband frame covered by interchangeable fabric overlays. Different fabric overlays are used with various interchangeable designs, colors, styles, textures, lengths, etc. Accessories may be attached with magnets that simulate animal ears, horns, LED lights, or other decorative accessories. In an alternative embodiment, headphones may be attached which fit directly on a user's head. A Bluetooth circuit receives signals and plays them through the headphones with direct sound conduction to the user's head. In another embodiment, microphones are also attached to the headband frame. This allows sounds to be sensed at the microphones, amplified and directly transmitted to the user's head to act as a hearing aid. In another embodiment, earmuff attachments can be added to the headband frame to add warmth, which optionally can be equipped with a Bluetooth circuit to play audio.

### CROSS-REFERENCE TO RELATED APPLICATION

This application claims priority to U.S. Provisional Patent Application 63/474,644 filed Sep. 1, 2022 and incorporates all subject matter of this Provisional Patent application to the extent that it does not contradict the content of this patent application.

### STATEMENT REGARDING FEDERALLY SPONSORED RESEARCH

Not Applicable.

### BACKGROUND

### 1. Field of Invention

The present invention relates to a stylish, changeable headband system. In particular, the present invention relates to a stylish, changeable headband system that includes a headphone speaker system.

### 2. Description of Related Art

Headbands are used to hold a user's hair in place so that it is not randomly blown around. These have also been used as fashion accessories.

Hair accessories being sold are a single color and texture and do not allow the user to modify them to be creative.

Different headbands can be used in different colors to coordinate or match the user's clothing.

Different headbands of different materials and fabrics may be used depending on the user's preferences. This practice typically results in the problem of having to buy many different headbands, which can be expensive and take up a large amount of space.

Users typically listen to music with earbuds inserted into their ear canals. These are driven wirelessly with a Bluetooth connection to a smartphone or other computing device. Since they are in the ear canals, hearing anything else, such as other people speaking, is difficult. It may also be a hazard when they do not hear audible warnings.

Since they are held in place by friction, they may be dislodged and lost.

There have been attempts to provide headphones that allow the user to hear other audible sounds while listening to the headphones while holding them in place. These tend to be large headphones with light plastic foam speak muffs. These tend to be large and bulky. These are also not very good-looking.

Users with problems with their auditory mechanisms do not benefit from devices that provide amplified sound to the user's ear canals and ear drum. Since the internal mechanisms are not functioning correctly, the conduction of sound vibrations does not make its way to the auditory nerve properly.

There are hearing aid designs that press against the user's bone structures and transmit sound waves directly through the bone to the auditory nerve. These are surgically implanted.

Currently, there is a need for a fashionable accessory to hold a user's hair in place that can be creatively modified and act to provide audible sounds to a user.

### BRIEF SUMMARY OF THE INVENTION

This invention relates to a new and novel headband assembly having a rigid, flexible headband frame sized and shaped to attach to a user's head and a replaceable, decorative, elongated fabric overlay.

The fabric overlay encloses a cavity that is sized and shaped to receive the headband frame.

The current invention may also be embodied as a novel headband assembly having a rigid, flexible headband frame sized and shaped to attach to a user's head, the headband frame having a first end and a second end, and a replaceable, decorative, elongated fabric overlay adapted to surround and cover the headband frame.

In another embodiment, the headband frame is not used, and the elastic band attaches to the ends of the fabric overlay using button features and openings in the fabric overlay that allow it to be secured to the user's head using the elastic band attachment.

The novel headband assembly may also include accessories magnetically attached to the headband frame wherein the accessories resemble animal ears, animal horns, antlers, or various holiday decorations, etc.

The novel headband assembly may also include a sound source, at least one speaker coupled to the sound source, attached to the headband frame in contact with the user's head, thereby functioning to provide sound to the user's head.

The sound source may be a receiver that receives Bluetooth signals from a computing device.

In another embodiment, the sound source includes at least one microphone, an amplifier system coupled to the microphone, and the speakers to amplify sounds received at the microphone and provide the amplified sounds to the speaker.

In another embodiment, earmuff attachments may be secured to the headband frame 1100 to provide warmth to the wearer.

### BRIEF DESCRIPTION OF THE DRAWINGS

The invention's advantages described in this application will become more apparent when read with the exemplary embodiment described in the specification and shown in the drawings. Further, the accompanying drawings and descriptions that follow, like parts, are indicated throughout the drawings and descriptions with the same reference numerals, respectively. The figures may not be drawn to scale, and the proportions of certain parts have been exaggerated for the convenience of illustration.

FIGS. 1A and 1B show two different views of the headband frame according to one embodiment of the current invention.

FIG. 2A is a view of the fabric overlay used to cover the headband frame of FIG. 1 according to one embodiment of the present invention.

FIG. 2B is a view of the opening in the fabric overlay used to insert an end of the headband frame.

FIG. 3 is a view showing the fabric overlay of FIG. 2A, partially fitting the headband frame of FIGS. 1A and 1B.

FIG. 4 shows an embodiment of a fabric overlay that covers the headband frame of FIGS. 1A and 1B by use of a small opening which may be at either end of the fabric overlay that receives either end of the headband frame and slides over to completely cover the headband frame

FIG. 5 shows a different view of the above-described embodiment of the fabric overlay.

FIG. 6 shows another embodiment of the current invention in which two fabric overlays, used without the headband frame, are wrapped together to create a “knotted” style and the button attachments and opening in the fabric overlay are utilized to secure, along with the elastic band, the fabric overlays to the user's head.

FIGS. 7 and 7A show an embodiment that utilizes an elastic band that attaches to the button features of the fabric overlay and extends around the back of a user's head to hold the headband system on with or without the use of the headband frame.

FIG. 8 shows another embodiment of the headband frame having an attached magnetic accessory, such as the “cat's ear” accessory shown here attached by use of magnets embedded within the headband frame of FIGS. 1A and 1B.

FIG. 9A shows a user wearing the headband with the attached cat ears accessories shown in FIG. 8.

FIG. 9B shows a user wearing a pendant accessory held by a chain attached to the headband frame by magnets.

FIG. 10A shows a diagram of a fabric overlay of another alternative embodiment of the current invention, having two fabric overlays shorter in size than the previously described with an opening in the middle as well as one end allowing both ends of the headband frame to be covered with two separate fabric overlays that are then knotted at the top or wrapped together using a pliable internal wire sewn into the seam of the fabric overlay.

FIG. 10B shows one fabric overlay mounted.

FIG. 10C shows the embodiment of FIG. 10B with both fabric overlays mounted and partially tied.

FIG. 10D shows the embodiment of FIGS. 10A, 10B and 10C in its finished form.

FIG. 11 is a side elevational view of two headband pieces attached to create a modular headband fame using internal magnets.

FIG. 12 is another embodiment of the headband system employing surface speakers which conduct directly through the user's head.

FIG. 13 shows the embodiment of internal magnets in the headband frame.

FIG. 14 shows an alternative embodiment of the current invention employing earmuffs and optionally Bluetooth circuits to receive and play audio through optional speakers in the earmuffs.

### DETAILED DESCRIPTION OF THE INVENTION

The present invention will now be described in detail by describing various illustrative, non-limiting embodiments with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

The terminology used herein is to describe particular embodiments only and is not intended to be limiting of the invention. As used herein, the term “and/or” includes any and all combinations of one or more of the associated listed items. As used herein, singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or some cases all, of the other disclosed techniques. Accordingly, for clarity, this description will refrain from repeating every possible combination of the individual steps in an unnecessary fashion. Nevertheless, the specification and claims should be read with the understanding that such combinations are entirely within the scope of the invention and the claims.

1. Theory

Earbuds are only held in place by friction. If not placed far into the user's ear canals, they tend to fall out and provide a lower sound level. Heavier earbuds can fall out of the user's ear canal and be damaged or lost.

Sound conducts well through solid materials, such as bone. Higher frequencies are attenuated more than lower frequencies when passing through soft materials such as skin, muscle, and fat. The human head has a thin covering of soft tissue over the skull, which is a very conductive material for sound waves. Sounds provided to the head will conduct to the auditory nerve.

2. Implementation

The headband hair accessory, also referred to as the “Humble Headband”, may be embodied in several ways with the following interchangeable features described below.

A fabric cover is wrapped over a headband frame in multiple different styles.

One or more fabric covers with openings at either end encloses, covers, or overlays a headband frame. Many covers with many different styles of fabrics having different colors, lengths, openings, buttons, wires, textures, patterns, etc., will be used with a single headband frame. These covers are interchangeable.

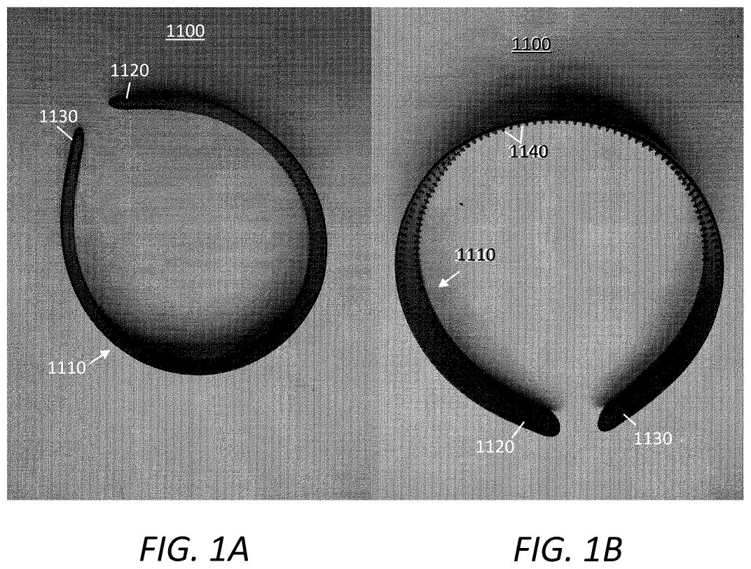

### FIGS. 1A and 1B

A headband frame 1100 is created from a rigid but flexible material, such as plastic and/or heavy cardboard. A preferred embodiment is to use biodegradable hemp plastic or recycled plastics to create headband frame 1100 in an environmentally conscious and ethical way. It is to be understood that this invention will cover all currently known materials for the headband frame. This disclosure is being presented to protect the idea regardless of the material used.

The headband frame 1100 has a curved body 1110 with two ends, a first end 1120 and a second end 1130. The headband frame 1100 may also include small projections 1140 that limit the movement of a fabric overlay 1200.

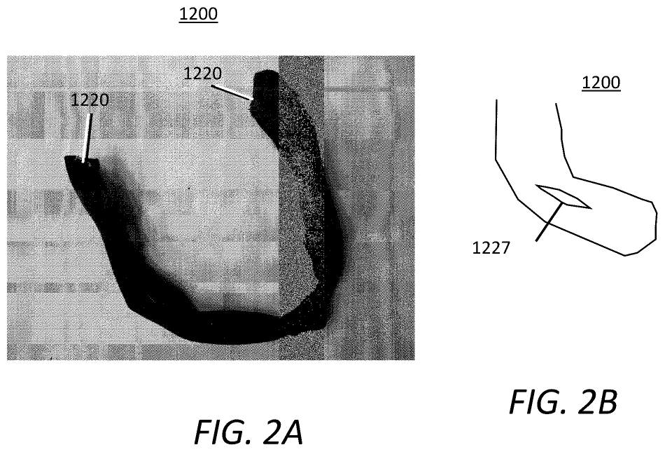

### FIG. 2A

The fabric overlay 1200, in the embodiment shown in FIG. 2A, is sewn to enclose an internal cavity. It has at least one opening to receive the headband frame. It can have different patterns, colors and use different fabric styles.

In an alternative embodiment, fabric overlay 1200 is shown in FIG. 2B having a pocket 1221 sewn into the ends of the fabric overlay, sized and shaped to receive and secure the ends of the headband frame.

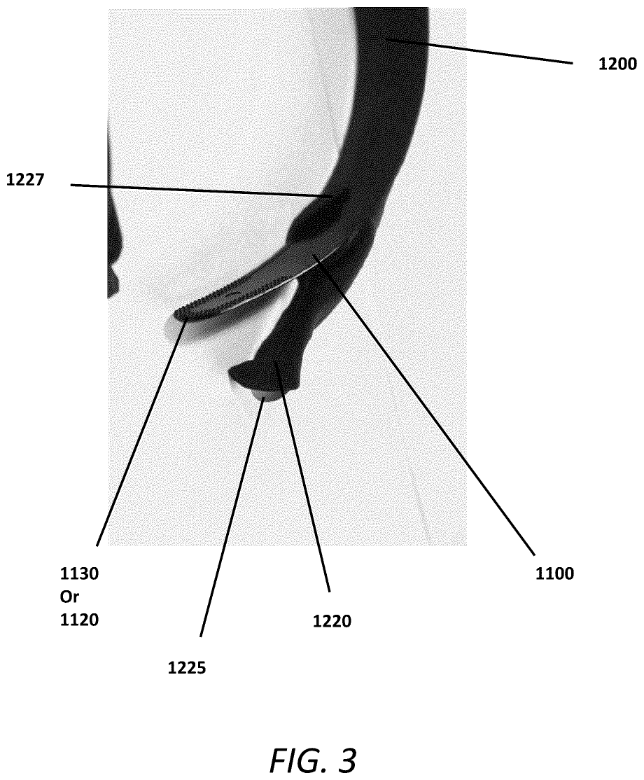

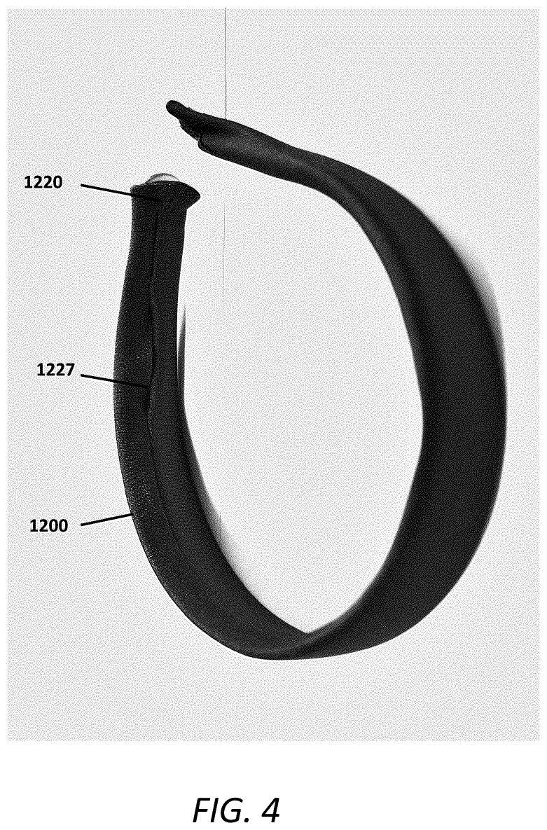

### FIGS. 3 and 4

The fabric overlay 1200 can be pulled over the headband frame 1100, as shown in FIGS. 3 and 4, using a slit opening 1227 in the fabric overlay 1200 or other means such as Velcro, fabric loops, snaps, or any known, conventional attachment device. The fabric overlay 1200 can employ button attachments 1225 that are fastened and secured to the ends 1220 of the fabric covering 1200.

FIG. 3 shows the fabric overlay 1200 partially covering the headband frame 1100. The headband frame 1100 is inserted through slit opening 1227 in the fabric overlay 1200 and sleeved from the frame end 1120 to 1130 to form a complete covering of the headband frame 1100.

FIG. 4 shows the headband frame 1100 fully inside of the fabric overlay 1200 and features slit opening 1227 in the fabric overlay 1200.

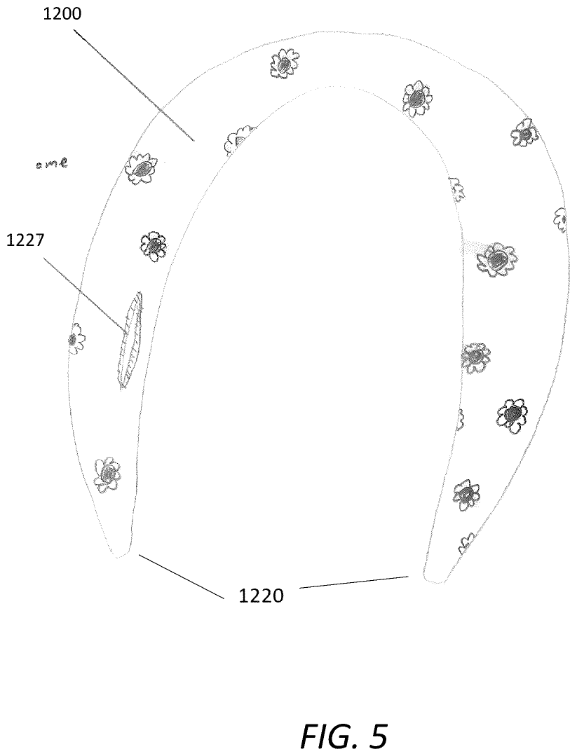

### FIG. 5

FIG. 5 shows an embodiment of the fabric overlay 1200, having reinforced stitching around slit opening 1227 that is intended to receive the headband frame 1100.

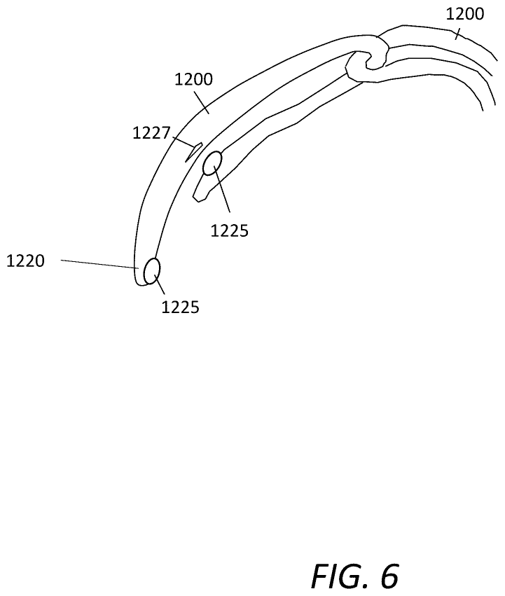

### FIG. 6

FIG. 6 shows another embodiment of the current invention in which the style is made from two or more fabric overlays 1200 used together to create a “twisted” style. The first fabric overlay piece 1200 is twisted back upon itself so that slit opening 1227 is proximate to and receives the button attachment 1225 of the opposite end of the fabric overlay 1200.

Similarly, a second fabric overlay 1200 is inserted through the loop created by the first fabric overlay and folded upon itself as to attach in the same manner as the first overlay piece 1200. Button attachments 1225 at either end of the first and second fabric overlays 1200 are employed to receive the elastic band and secure the headband around the back of the user's head.

The fabric overlays 1200 may be made of many different colors, patterns, textures, fabrics, and materials and may be used interchangeably with or without the headband frame 1100.

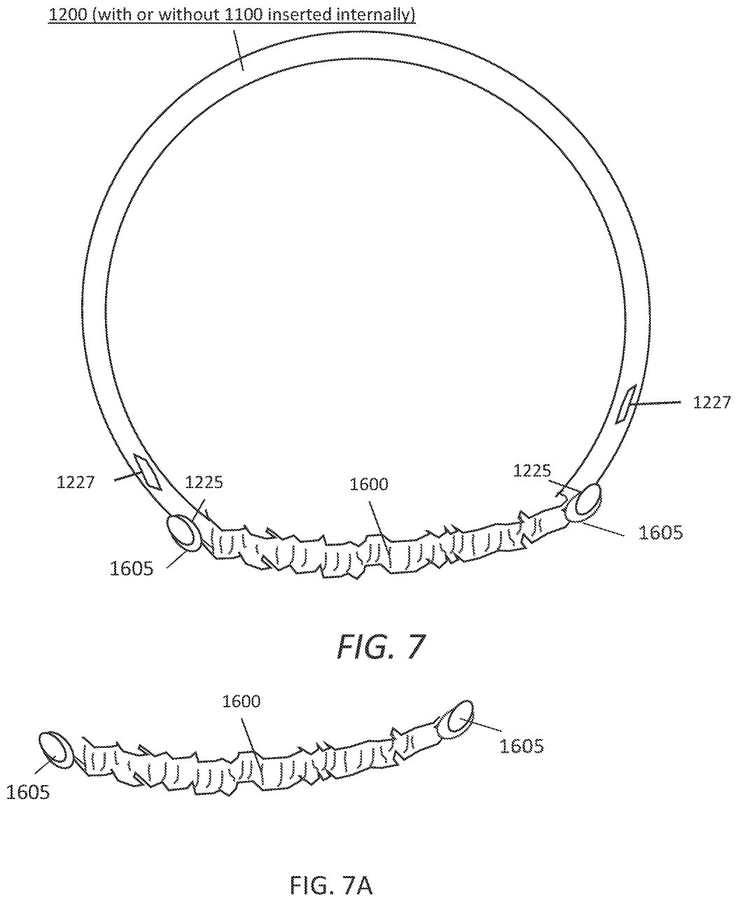

### FIG. 7 & FIG. 7A

In a different embodiment, as shown in FIG. 7, an elastic band (which may be what is commonly referred to as a ‘scrunchie’) 1600 has two loop ends 1605 that each attach to the button 1225 at either ends 1220 of the fabric overlay 1200. The elastic band 1600 is worn around the back of the user's head securing the fabric in place. In this embodiment, the fastener is a loop on the elastic band 1600 that fits over and secures to the buttons 1225 mounted on the ends 1220 of the fabric overlay 1200.

Since the elastic securing band 1600 will hold the fabric overlay 1200 in place, it can be used with or without the headband frame 1100.

Fasteners may also be snaps, hook-and-loop attachments, or any other known conventional fasteners. Optionally, the elastic securing band should have a conventional slider buckle that lengthens or shortens the elastic securing band 1600 according to the user's needs.

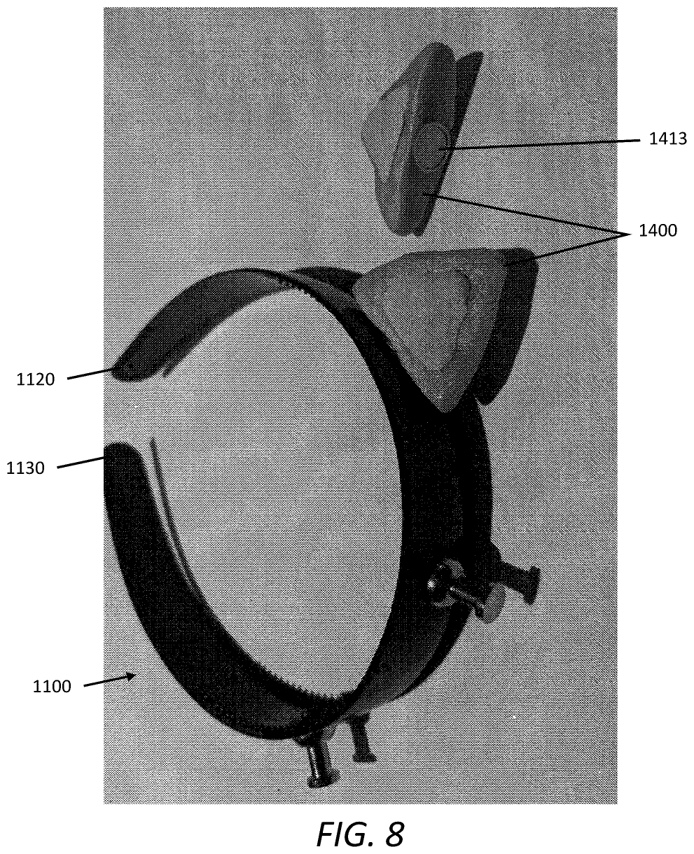

### FIG. 8

In a different embodiment shown in FIG. 8, the headband frame 1100 will be equipped with headband magnets 1411 at interspaces within the plastic to allow accessories to be magnetically held to the headband frame. These accessories 1400 can be added and changed continuously. The accessories may also feature a metal plate or an internal magnet 1413 to secure them to the headband frame.

In an embodiment, headband frame 1100 may have embedded headband magnets 1411 spaced along its long axis, allowing for different accessories 1400 to be added and removed easily, but can remain in place during normal wear. The accessories 1400 will have an internal accessory magnet 1413 at the base to secure it to the headband frame 1100 with or without the fabric overlay 1200.

Any number of conventionally known securing devices similar to those described in this application may be used. As indicated above, this patent is intended to protect the overall idea of the invention and is not limited to any materials stated in this application.

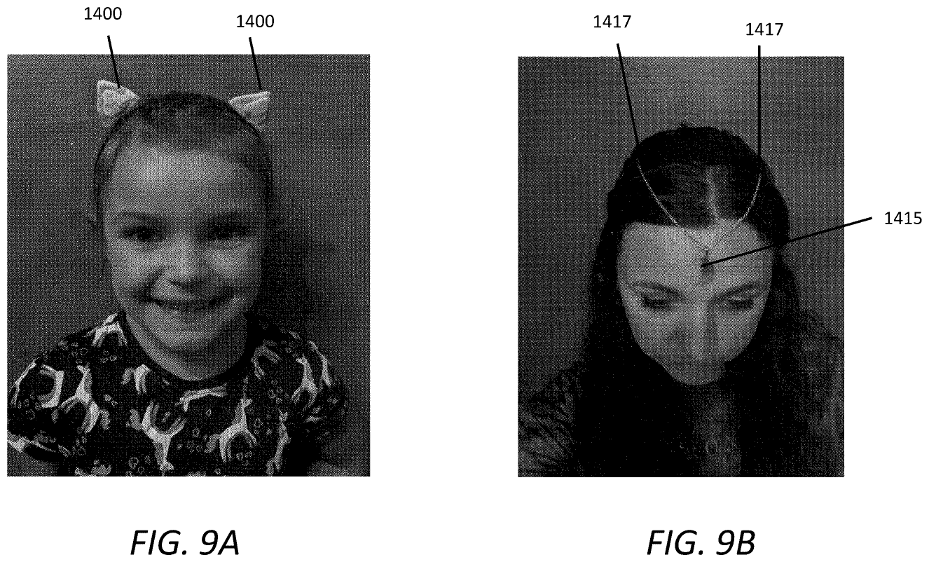

### FIG. 9A

FIG. 9A shows a user wearing the headband system 1000 with the magnetic accessory 1400 (attached cat ears accessories) of FIG. 8. The magnetic accessories 1400 have a base having a material that is attracted to the magnets in the headband frame (not visible from this view). Alternatively, the headband frame could have other magnets or metal. These hold the accessories (ears) 1400 to the headband frame.

Various types of magnetic accessories 1400 can be used, ranging from antlers, holiday décor, LED lights, antennas, bows, head dressings, flowers, knots, et cetera but not limited to

### FIG. 9B

FIG. 9B shows a user wearing a pendant accessory held by a chain attached to the headband frame. The pendant chain and pendant are considered to be accessories 1400. Each end of the pendant chain is attached to magnets in the headband frame (not visible from this view).

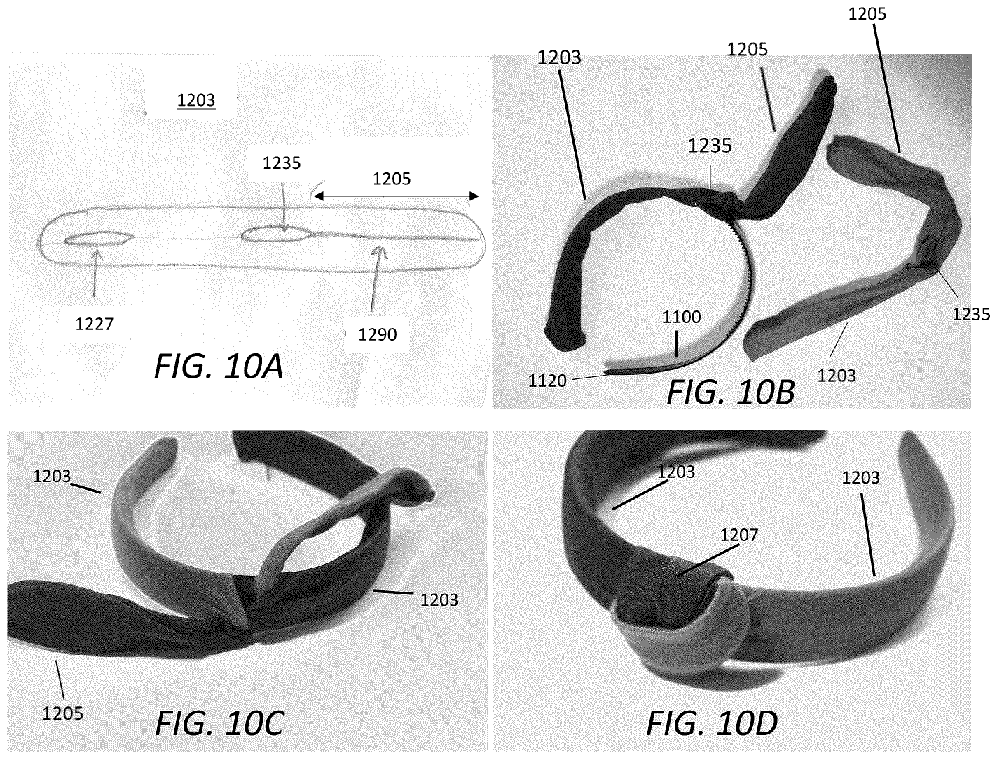

### FIG. 10A

FIG. 10A shows another alternative embodiment of the current invention, having a in which the fabric overlay 1200 is actually two modified fabric overlays 1203. Fabric overlay 1203 has a slit opening 1227, but also has an additional middle opening 1235 along the seam of its long axis. It also includes a lengthened fabric end or “tail” 1205 having a pliable, internal wire 1290 that runs the length of the “tail” 1205.

### FIG. 10B

FIG. 10B shows the embodiment of FIG. 10A so that the first end 1120 of headband frame 1100 had initially entered slit opening 1227 and exited middle opening 1235 and headband frame end 1130 (not shown) is secured within the fabric overlay 1203. The free length of fabric, or “tail” 1205 is seen in an unfinished form with a second fabric overlay 1203 not yet mounted on the headband frame 1100.

### FIG. 10C

FIG. 10C shows an embodiment of FIGS. 10A and 10B in a partially finished form where the fabric overlays 1203 are mounted on the opposite ends of the headband frame 1100. The tails 1205 of the two fabric overlays 1203 are seen partially knotted on the superior aspect of the headband frame 1100.

### FIG. 10D

FIG. 10D shows the embodiment of FIGS. 10A, 10B, and 10C in its finished form, where the tail 1205 of fabric pieces 1203 are tied into a knot 1207 along the superior aspect of the headband frame held in place by the internal, pliable wire 1290.

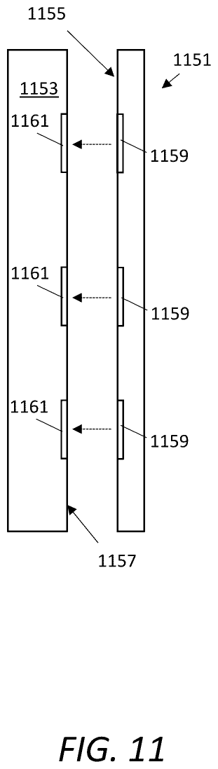

### FIG. 11

In an alternative embodiment, the headband frame 1100 is made of two headband frames 1153, 1151 of different widths attached together widthwise at mating surfaces 1155, 1157. A plurality of interface magnets 1161 are attached to a first mating surface 1157 of first headband frame 1153. The material used for the second headband frame 1151 is attracted to magnets and/or has interface magnets 1159 to hold the first and second headband frames 1151, 1153 together as a single unit.

If the materials used for the second headband frame 1151 are not attracted to magnets, then receivers 1159 are attached to a second mating surface 1157 of the second headband frame 1153 at locations corresponding to the interface magnets 1159.

The receivers 1159 may be plates that include any material attracted to magnets, or magnets positioned such that their opposite polarity interfaces with the interface magnets 1161 to attract each other, holding the first headband frame 1151 to the second headband frame 1153 as a single double-wide headband frame.

This design allows the user to select a wide or narrow headband frame. If the first and second headband frames 1151 and 1153 are not equal width, the user can choose to use headbands of three different widths.

FIG. 11 is a side elevational view of two headband pieces that attach to create a modular headband fame.

The headband frame in this embodiment is a first headband frame 1151 and a second headband frame 1153 (or more) that are removably held together to create multiple headband widths.

The first headband frame 1151 has a first mating surface 1155 running its length.

The second headband frame 1153 has a second mating surface 1157 also running its length.

Interface magnets 1161 are mounted on the first mating surface 1157. Receivers 1159 are mounted on the second mating surface 1155 at locations corresponding to magnets 1161. When placed in proper orientation at a close distance, the magnets 1161 attach to the receivers 1159 to removably hold the first and second headband frames together. If the headband frames 1153, 1151 have different widths, it allows the user to select a headband frame having a width equal to the first headband frame 1151 or width of the second headband frame 1153, or the width of the combined headband frames 1151, 1153.

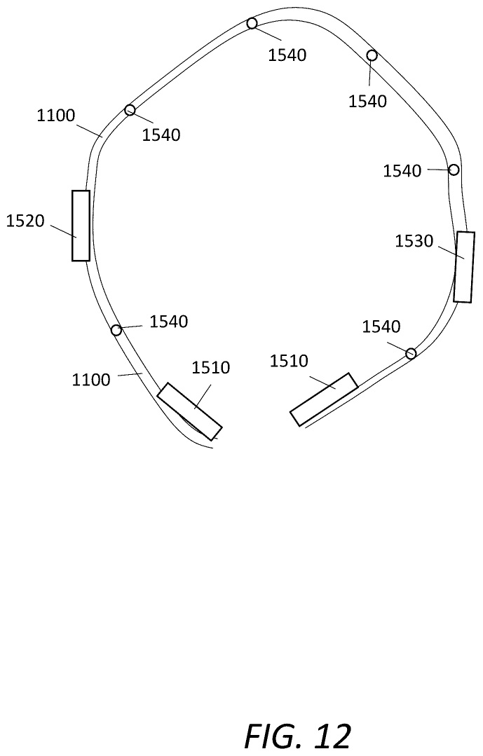

FIG. 12 is another embodiment of the headband system employing surface speakers which conduct directly through the user's head.

Speakers 1510 are attached to the headband frame 1100. Due to the nature of headbands, they press against the user's head to hold them to the user. The speakers 1510, placed as shown, will press against the user's head directly upon his/her hair and skin.

In one embodiment, a conventional Bluetooth circuit 1520 is coupled to the headphones. The Bluetooth circuit 1520 can now receive music and other audio signals from another Bluetooth device acting as a source of the music and audio. The Bluetooth circuit 1520 then plays the audio received through the surface speakers 1510. The surface speakers 1510 transmit sound directly through the user's head. Users tend to enjoy this since it transmits low frequencies better than conventional headphones.

Many people who have reduced hearing ability do not like to wear hearing aids. Even though hearing aids are small now, they are still visible in a user's ear. Many people feel that using hearing aids makes them look older and tend not to use their hearing aids.

In another embodiment, headband frame 1100 or headband frame 1100 with fabric overlay 1200 can be fitted with a plurality of microphones 1540 coupled to an amplifier 1530 that drives speakers 1510. This embodiment would amplify sounds received at the microphones 1540 and provide those amplified sounds to speaker 1540 on the surface of the user's head. This arrangement has the effect of allowing the user to hear better.

It is important to note that certain types of hearing deficiencies are due to improper mechanical conductance of the bones in the user's ear, such as the stapes and anvil. These are referred to as “mechanical transmission problems”. Simply amplifying sounds and providing the amplified sound to the user's eardrum does little to help the hearing of a user with bone transmission problems.

However, it is known that sounds may be effectively transmitted through the bone of a user's skull to the auditory nerve to increase hearing ability. The current invention performs a similar function. Sounds received at the microphones 1540 are passed to the amplifier 1530, amplified, and provided to speakers 1510. These speakers provide physical vibrations to the bones in the user's head that propagate to the auditory nerve. Since the auditory nerve is still functional in many people with mechanical transmission problems, the system increases the user's ability to hear.

In alternative embodiments, circuitry and switches may be added to allow the user to select which microphones to use to ‘listen’. For example, if microphones are positioned on the front ends of the headband frame 1100 and the rear side of the headband frame 1100 (when it is being worn), one can select microphones 1540 facing forward to hear noises coming from the front of the person. Similarly, microphones facing rearward would be selected to hear sounds from behind the user.

Microphones could be selected to focus in any direction to focus on discussions from specific people while not being drowned out by other conversations.

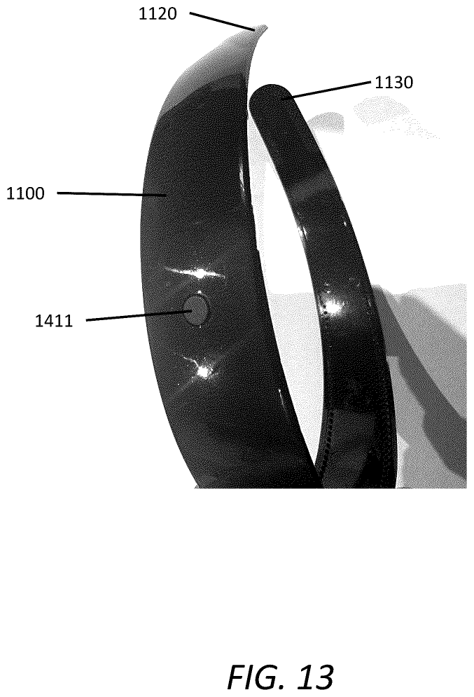

FIG. 13 shows headband frame 1100 equipped with internally inserted headband magnets 1411.

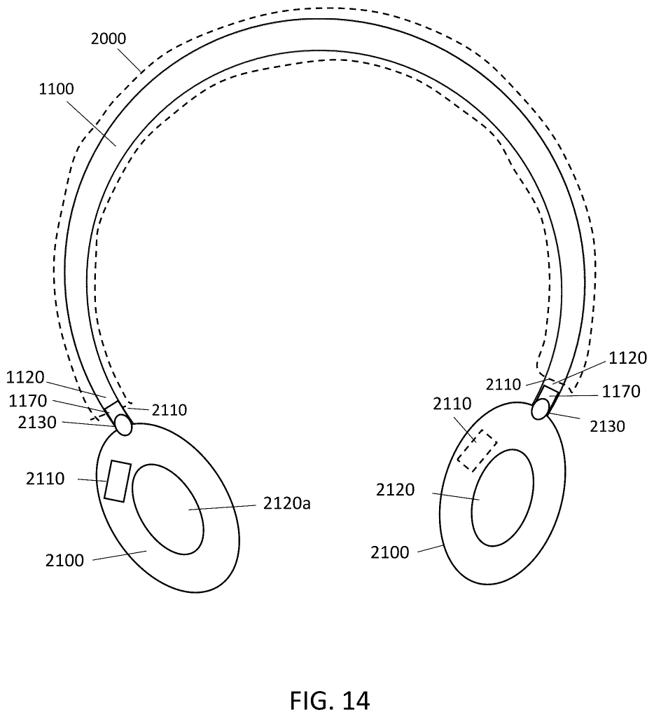

FIG. 14 is an alternative embodiment of the headband system in which the headband frame 1100 can receive earmuffs 2100 that are attached to an attachment system 2130 that are directly attached to the headband frame ends 1120 and 1130. The earmuffs 2100 may be equipped with a Bluetooth circuit 2110 that can receive electronic signals from another Bluetooth device to reproduce music and audio signals. The Bluetooth circuit 2110 has amplifiers and other electronics to play the audio received through the speaker 2120a. Second speaker 2120b can be driven by a wire connection from the Bluetooth circuit 2110 along the headband 1100 to the other speaker 2120b.

In an alternative embodiment, there is a second Bluetooth Circuit 2110 that drives the right speaker 2120.

If the Bluetooth communication ability is not being utilized, the current embodiment also provides warmth to the wearer's ears in the cold months.

The earmuffs feature an attachment 2130 that attaches the earmuffs 2100 to the exposed headband end 1120, 1130.

potentially using a hook and eye system, Velcro, buttons, snaps, or any other conventionally known attachment system.

The earmuffs have the ability to be adjustable in length (not shown here) to fit around the head shape of any wearer.

FIG. 14 in an optional embodiment, a fabric overlay 2000 (shown as a dashed line) has openings 2110 at either end that receive the headband frame 1100 and fit over it as shown. The headband frame ends 1120, 1130 extend out past the fabric overlay 2000 exposing them.

On the left, an attachment 2130 attaches the headband frame ends 1120 to the left earmuff 2100. The attachment 2130 could potentially be a hook and eye system, Velcro, buttons, snaps, or any other conventionally known attachment system. Attachment 2130 is a removable attachment such that earmuffs 2100 may be attached so that they can be easily removed.

In an alternative embodiment, an extension 1170 is connected between the headband ends 1120, 1130 and the earmuffs 2100 to allow adjustment to position them over the user's ears.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the preceding aspects are illustrative, and no single feature or element essential to all possible combinations may be claimed in this or a later application.

We claim:

1. A novel headband assembly comprising:
a. a rigid, flexible headband frame sized and shaped to attach to a user's head, and
b. a replaceable, decorative, elongated fabric overlay adapted to surround and attach to the headband frame.

2. The novel headband assembly of claim 1 wherein:
a. the fabric overlay encloses a cavity that is sized and shaped to receive the headband frame.

3. The novel headband assembly of claim 1 wherein:
a. the fabric overlay has an opening into the cavity large enough to receive the headband frame.

4. The novel headband assembly of claim 1 further comprising:
a. accessories magnetically attached to the headband frame.

5. The novel headband assembly of claim 4 wherein:
a. the accessories resemble animal ears.

6. The novel headband assembly of claim 4 wherein:
a. the accessories resemble one of animal horns, antlers.

7. The novel headband assembly of claim 4 wherein:
a. the accessories include at least one of holiday decorations and novelty designs.

8. The novel headband assembly of claim 1 further comprises:
a. a sound source,
b. at least one speaker coupled to the sound source, attached to the headband frame in contact with the user's head, thereby functioning to provide sound to the user's head.

9. The novel headband assembly of claim 1 wherein:
a. the sound source is a receiver adapted to receive Bluetooth signals from a computing device.

10. The novel headband assembly of claim 1 wherein:
a. the sound source comprises:
i. at least one microphone,
ii. an amplifier system coupled to the microphone and the speaker to amplify sounds received at the microphone and provide the amplified sounds to the speaker.

11. A novel headband assembly comprising:
a. a rigid, flexible headband frame sized and shaped to attach to a user's head, the headband frame having a first end and a second end;
b. a replaceable, decorative, elongated fabric overlay adapted to surround and cover the headband frame; and
c. an elastic band attached between the first end and the second end of the headband frame, sized to fit around a back side of a user's head, thereby holding the headband assembly to the user's head.

12. The novel headband assembly of claim 11, further comprising:
an earmuff attached to the first end of the headband frame; and
an earmuff attached to the second end of the headband frame.

13. The novel headband assembly of claim 11 further comprises:
a. a sound source,
b. at least one speaker coupled to the sound source, attached to the headband frame in contact with the user's head, thereby functioning to provide sound to the user's head.

14. The novel headband assembly of claim 11 wherein:
a. the sound source is a receiver adapted to receive Bluetooth signals from a computing device.

15. The novel headband assembly of claim 11 wherein:
the sound source comprises:
i. at least one microphone,
ii. an amplifier system coupled to the microphone and the speaker to amplify sounds received at the microphone and provide the amplified sounds to the speaker.

16. The novel headband assembly of claim 11 further comprising:
accessories magnetically attached to the headband frame.

17. The novel headband assembly of claim 16 wherein:
the accessories resemble one of animal ears, animal horns, antlers, LED lights, antennas, and novelty designs.

18. A novel headband assembly comprising:
a. a decorative, elongated fabric overlay having a first end and a second end, adapted to fit around a user's head; and
b. an elastic band attached between the first end and the second end sized to fit around a back side of a user's head, thereby holding the headband assembly to the user's head.

19. The novel headband assembly of claim 18 further comprises:
a. a sound source,
b. at least one speaker coupled to the sound source, attached to the headband frame in contact with the user's head, thereby functioning to provide sound to the user's head.

20. The novel headband assembly of claim 18 wherein:
the sound source is a receiver adapted to receive Bluetooth signals from a computing device.

21. The novel headband assembly of claim 18 wherein:
the sound source comprises:
i. at least one microphone,
ii. an amplifier system coupled to the microphone and the speaker to amplify sounds received at the microphone and provide the amplified sounds to the speaker.
